(19) United States
(12) Patent Application Publication
(10) Pub. No.: US 2024/0170785 A1
(43) Pub. Date: May 23, 2024

(54) STRUCTURAL ASSEMBLY FOR BATTERY STRUCTURE OF ELECTRIC VEHICLE

(71) Applicant: Ford Global Technologies, LLC, Dearborn, MI (US)

(72) Inventors: AmirReza Latif, Grosse Pointe, MI (US); Vladimir Vladimirovich Bogachuk, West Bloomfield, MI (US); Robert Reiners, Ypsilanti, MI (US); Derek Langley, Dearborn, MI (US); Shawn Michael Morgans, Chelsea, MI (US)

(73) Assignee: Ford Global Technologies, LLC, Dearborn, MI (US)

(21) Appl. No.: 17/993,290

(22) Filed: Nov. 23, 2022

(51) Int. Cl. H01M 50/249; B60L 50/64; H01M 50/204

(52) U.S. Cl. CPC H01M 50/249; B60L 50/64; H01M 50/204; H01M 2220/20

(57) ABSTRACT

The battery structure for an electric vehicle includes battery arrays. A first battery array includes first walls that are secured to each other to form a first unitized structure that is configured to house a first cell stack. One first wall of the first walls includes a first vertical portion, a first upper portion, and a first lower portion. A second battery array includes second walls that are secured to each other to form a second unitized structure that is configured to house a second cell stack. One second wall of the second walls includes a second vertical portion and a second upper portion. The second vertical portion is spaced apart from the first vertical portion. The second upper portion extends toward the first vertical portion from an upper end of the second vertical portion and is secured to the first upper portion of the first battery array.

### FIELD

The present disclosure relates to a structural assembly for a battery structure of an electric vehicle.

### BACKGROUND

The statements in this section merely provide background information related to the present disclosure and may not constitute prior art.

Electric vehicles differ from conventional motor vehicles because they are driven by one or more rechargeable battery packs having lithium-ion batteries, for example, or any other suitable electrical power storage units. The battery pack typically powers one or more motors to drive a set of wheels using battery arrays. In some electric vehicles, the battery arrays include a structural assembly that surrounds battery pouches, especially for vehicles capable of traveling long distances (e.g., electric vehicles capable of traveling more than 500 miles).

The present disclosure addresses these and other issues related to battery arrays in electric vehicles.

### SUMMARY

This section provides a general summary of the disclosure and is not a comprehensive disclosure of its full scope or all of its features.

In one form, the present disclosure provides a battery structure for an electric vehicle. The battery structure includes a first battery array and a second battery array. The first battery array includes a plurality of first walls that are secured to each other to form a first unitized structure that is configured to house a first cell stack. One first wall of the plurality of first walls includes a first vertical portion, a first upper portion, and a first lower portion. The second battery array includes a plurality of second walls that are secured to each other to form a second unitized structure that is configured to house a second cell stack. One second wall of the plurality of second walls includes a second vertical portion and a second upper portion. The second vertical portion is spaced apart from the first vertical portion. The second upper portion extends toward the first vertical portion from an upper end of the second vertical portion and is secured to the first upper portion of the first battery array. The first upper portion extends toward the second vertical portion from an upper end of the first vertical portion. The first lower portion extends toward the second vertical portion from a lower end of the first vertical portion and is connected to the one second wall.

In variations of the battery structure according to the above paragraph, which may be implemented individually or an any combination: the one first wall further includes a first rib extending from the first vertical portion from a location between the first upper portion and the first lower portion, the one second wall further includes a second rib extending from the second vertical portion and secured to the first rib; an interlock assembly secures the first lower portion of the one first wall to the one second wall; the interlock assembly includes a flange defining a recess and extending from one of a lower end of the second vertical portion and an end of the first lower portion, and a protrusion received in the recess of the flange and projecting from the other one of the lower end of the second vertical position and the end of the first lower portion; the one second wall further includes a pair of flanges extending perpendicular from respective ends of the second vertical portion toward the first vertical portion; a third battery array stacked on the first battery array and including a plurality of third walls secured to each other to form a third unitized structure that is configured to house a third cell stack, one third wall of the plurality of third walls includes a third vertical portion and a second lower portion, the second lower portion extends toward the second vertical portion from a lower end of the third vertical portion and is secured to the first upper portion of the one first wall and secured to the second upper portion of the one second wall; another first wall of the plurality of first walls of the first battery array is opposite the one first wall and includes a third vertical portion, a third upper portion, and a second lower portion, the third upper portion and the second lower portion extend from the third vertical portion in a direction away from the one first wall; a third battery array adjacent to the first battery array and connected to the another first wall of the first battery array; and a plurality of mechanical fasteners extending through the first upper portion and through the second upper portion to secure the first upper portion and the second upper portion to each other.

In another form, the present disclosure provides a battery structure for an electric vehicle. The battery structure includes battery tray, a plurality of cross beams, and a plurality of battery arrays. The cross beams are supported by the battery tray and are spaced apart from each other along a longitudinal direction of the electric vehicle. Each cross beam extends in a transverse direction. The battery arrays are disposed within the battery tray and includes a first battery array and a second battery array. The first battery array includes a plurality of first walls that are secured to each other to form a first unitized structure that is configured to house a first cell stack. One first wall of the plurality of first walls includes a first vertical portion, a first upper portion, and a first lower portion. The second battery array includes a plurality of second walls that are secured to each other to form a second unitized structure that is configured to house a second cell stack. One second wall of the plurality of second walls includes a second vertical portion and a second upper portion. The second vertical portion is spaced apart from the first vertical portion. The second upper portion extends toward the first vertical portion from an upper end of the second vertical portion and is secured to the first upper portion of the first battery array. The first upper portion and the first lower portion extend toward the second vertical portion from the first vertical portion. The first lower portion of the one first wall is connected to the one second wall and connected to one cross beam of the plurality of cross beams.

In variations of the battery structure according to the above paragraph, which may be implemented individually or an any combination: the one first wall and the one second wall are spaced apart from a bottom panel of the battery tray; the one first wall further includes a first rib extending from the first vertical portion from a location between the first upper portion and the first lower portion and the one second wall further includes a second rib extending from the second vertical portion and engaging the first rib; a pair of gussets, each gusset secured to a respective side wall of the battery tray and secured to the first and second ribs; fasteners extending through a respective gusset of the pair of gussets and through the first and second ribs to secure the respective gusset to the first and second ribs; the one second wall further includes a pair of flanges extending perpendicular from respective ends of the second vertical portion toward the first vertical portion; a pair of energy absorbing structures, each energy absorbing structure secured to a respective flange of the pair of flanges and extending outboard toward a respective wall of the battery tray; and the energy absorbing structure is spaced apart from the respective wall of the battery tray.

In yet another form, the present disclosure provides a battery structure for an electric vehicle. The battery structure includes battery tray, a plurality of cross beams, and a plurality of battery arrays. The cross beams are disposed on a bottom panel of the battery tray and are spaced apart from each other along a longitudinal direction of the electric vehicle. Each cross beam extends in a transverse direction. The battery arrays are disposed within the battery tray and includes a first battery array, a second battery array, a third battery array and a pair of energy absorbing structures. The first battery array includes a plurality of first walls that are secured to each other to form a first unitized structure that is configured to house a first cell stack. One first wall of the plurality of first walls includes a first vertical portion, a first upper portion, and a first lower portion. The second battery array includes a plurality of second walls that are secured to each other to form a second unitized structure that is configured to house a second cell stack. One second wall of the plurality of second walls includes a second vertical portion, a second upper portion, and a pair of flanges. The second vertical portion is spaced apart from the first vertical portion. The second upper portion extends toward the first vertical portion from an upper end of the second vertical portion and is secured to the first upper portion of the first battery array. The pair of flanges extend perpendicular from respective ends of the second vertical portion toward the first vertical portion. The third battery array is stacked on the first battery array and includes a plurality of third walls secured to each other to form a third unitized structure that is configured to house a third cell stack. One third wall of the plurality of third walls includes a third vertical portion and a second lower portion. The second lower portion extends toward the second vertical portion from the third vertical portion and is secured to the first upper portion of the one first wall and secured to the second upper portion of the one second wall. Each energy absorbing structure is secured to a respective flange of the pair of flanges and extends outboard toward a respective wall of the battery tray.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a vehicle including a battery housing assembly according to the principles of the present disclosure;

FIG. 2 is a perspective view of the battery housing assembly of FIG. 1;

FIG. 3 is another perspective view of the battery housing assembly of FIG. 1 illustrated with battery arrays and a lid of the battery housing assembly removed for clarity;

FIG. 4 is another perspective view of the battery housing assembly of FIG. 1 including one battery array disposed therein and with the lid of the battery housing assembly removed for clarity;

FIG. 5A is another perspective view of the battery housing assembly of FIG. 1 including a plurality of battery arrays disposed therein and with the lid of the battery housing assembly removed for clarity;

FIG. 5B is another perspective view of the battery housing assembly of FIG. 1 including a plurality of battery arrays disposed therein and with the lid of the battery housing assembly removed for clarity;

FIG. 6 is a perspective view of one battery array of the battery housing assembly of FIG. 1;

FIG. 7 is another perspective view of one battery array of the battery housing assembly of FIG. 1;

FIG. 8 is a cross-sectional view of the battery housing assembly of FIG. 1 showing adjacent battery arrays secured to each other;

FIG. 9 is another cross-sectional view of the battery housing assembly of FIG. 1 showing adjacent battery arrays secured to each other;

FIG. 10 is another cross-sectional view of a portion of the battery housing assembly of FIG. 1;

FIG. 11 is another cross-sectional view of the battery housing assembly of FIG. 1;

FIG. 12 is another cross-sectional view of the battery housing assembly of FIG. 1;

FIG. 13 is a perspective view of another battery housing assembly according to the principles of the present disclosure including a plurality of battery arrays disposed therein and with a lid of the battery housing assembly removed for clarity;

FIG. 14 is a cross-sectional view of the battery housing assembly of FIG. 13; and

FIG. 15 is another cross-sectional view of the battery housing assembly of FIG. 13.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

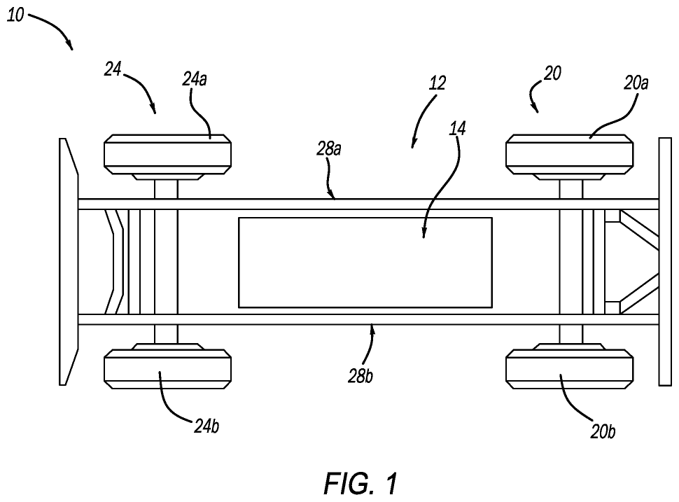

With reference to FIG. 1, a vehicle 10 such as an electric vehicle is shown. In the example provided, the electric vehicle is a battery electric vehicle (BEV). In other examples, the electric vehicle may be a hybrid electric vehicle (HEV), a plug-in electric vehicle (PHEV), or a fuel cell vehicle, among others. The vehicle 10 includes a vehicle frame 12 and a battery structure or battery housing assembly 14. The vehicle frame 12 is the main supporting structure of the vehicle 10, to which various components are attached either directly or indirectly. The vehicle frame 12 includes opposed longitudinal rails 28a, 28b. The rails 28a, 28b are spaced apart from each other and may establish a length of the vehicle frame 12. In the example illustrated, the vehicle 10 is a body on frame vehicle architecture, though other configurations can be used, such as a unibody architecture, for example.

The battery housing assembly 14 powers a rear motor (not shown) to drive rear wheels 20a, 20b of a set of rear wheels 20 via a rear axle and/or powers a front motor (not shown) to drive front wheels 24a, 24b of a set of front wheels 24 via a front axle.

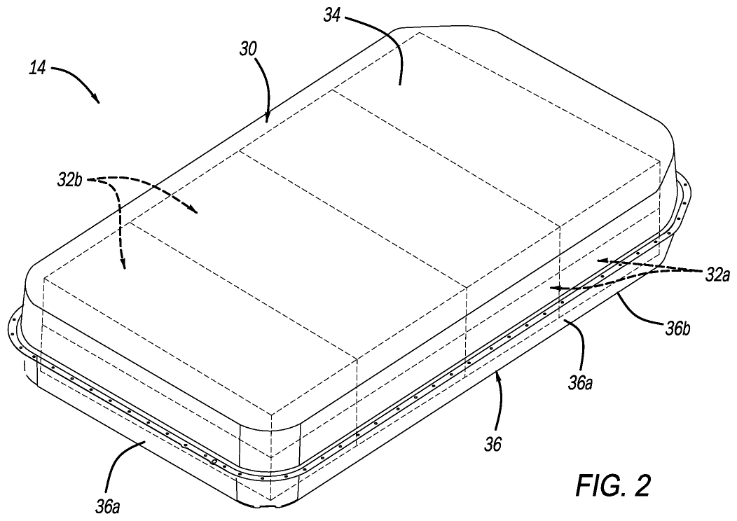

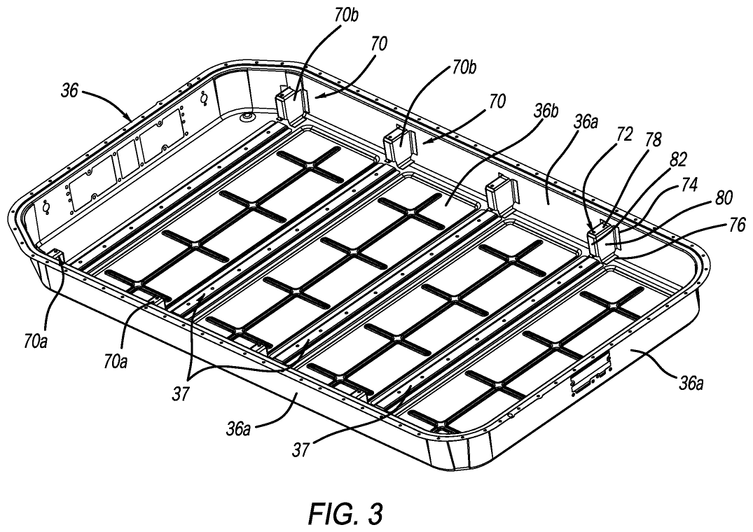

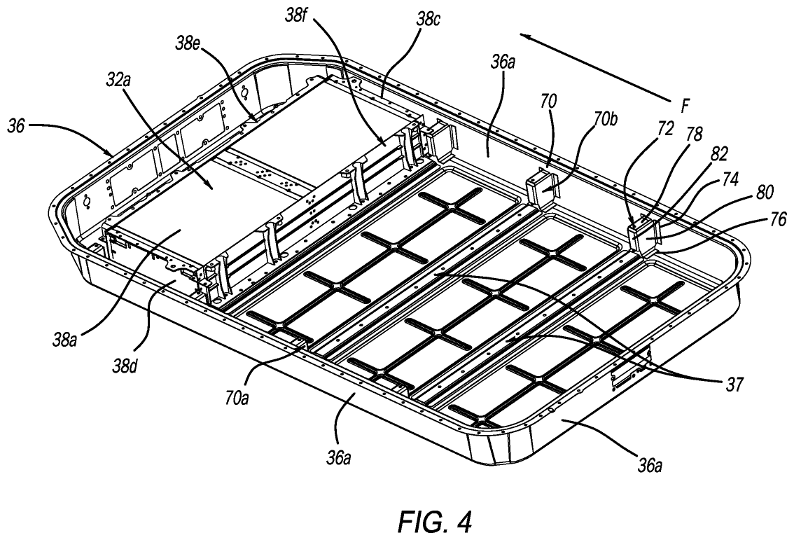

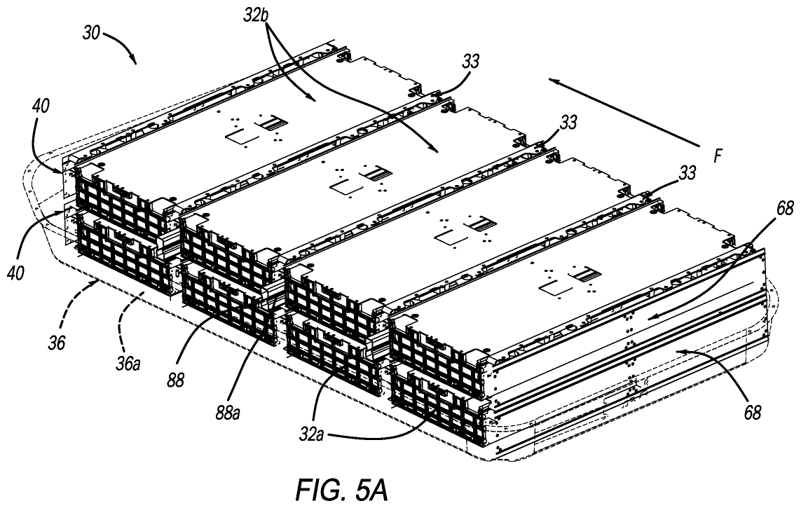

With reference to FIGS. 2-5B, the battery housing assembly 14 includes a battery tray or housing 30 and a plurality battery arrays 32a, 32b (FIGS. 4, 5A, and 5B). The battery housing 30 is an enclosure which provides a structural surrounding and sealed compartment for the battery arrays 32a, 32b and other battery components such as cooling lines, support brackets, and wiring disposed therein or extending therethrough. The battery housing 30 may be disposed at various locations of the vehicle 10 and is mounted to the vehicle frame 12. In this way, the battery housing 30 is supported by the vehicle frame 12 and is remote from a passenger cabin (not shown) and cargo compartments (not shown) of the vehicle 10, therefore, not occupying space that would otherwise be available for passengers or cargo. The battery housing 30 includes a cover or lid 34, a body 36, a plurality of cross beams 37 (FIGS. 3 and 4), and a seal (not shown). The lid 34 is removably coupled to the body 36 via mechanical fasteners such as bolts or screws (not shown), for example. In this way, the lid 34 may be removed to service the battery arrays 32a, 32b disposed within the battery housing 30.

The body 36 includes a plurality of side walls or panels 36a and a bottom wall or panel 36b. The side walls 36a are manufactured via stamping, for example, and extend in a vertical direction. The side walls 36a define an outer boundary of the battery housing 30 and are secured to each other via welding or an adhesive, for example. The bottom wall 36b supports the battery arrays 32a, 32b disposed within the battery housing 30 and is secured to lower portions of the side walls 36a.

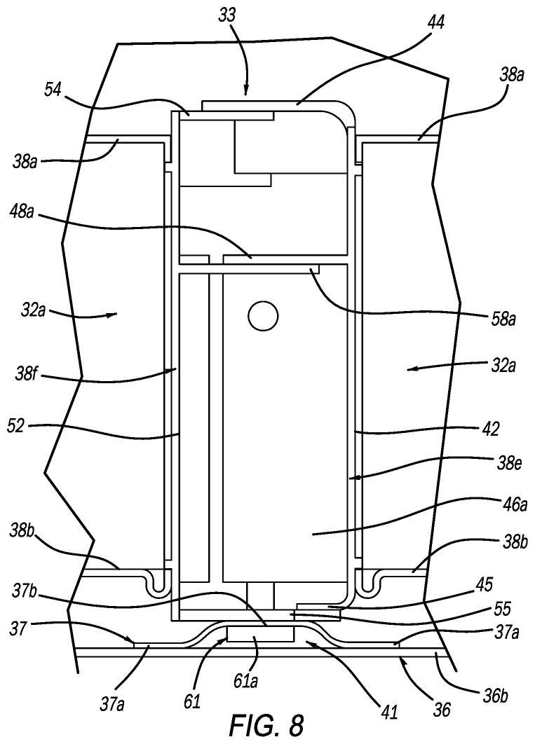

With additional reference to FIG. 8, the cross beams 37 are supported on and secured to the bottom wall 36b of the body 36 and are evenly spaced apart from each other in a longitudinal direction of the vehicle 10. Each cross beam 37 also extends in a transverse direction of the vehicle 10 and at least partially supports adjacent battery arrays 32a, 32b of the battery housing assembly 14. Each cross beam 37 includes a pair of end portions 37a and a central portion 37b. The pair of end portions 37a are secured to an upper surface of the bottom wall 36b of the battery housing 30. In one example, the pair of end portions 37a are secured to the upper surface of the bottom wall 36b by welding. In some forms, the pair of end portions 37a are secured to the upper surface of the bottom wall 36b by mechanical fasteners such as rivets, threaded screws, and/or bolts, for example. The central portion 37b is located above the pair of end portions 37a and has a planar surface. The central portion 37b and the bottom wall 36b of the battery housing 30 cooperate to form a cavity 41.

The seal is disposed around a periphery of the body 36 and is engaged with the body 36 and the lid 34. In this way, fluids, debris and other materials are inhibited from entering into the battery housing 30.

As shown in FIGS. 2, 5A, and 5B, the plurality of battery arrays 32a, 32b are disposed within the battery housing 30. In the example illustrated, the battery arrays 32a are arranged within the battery housing 30 in a side-by-side arrangement to form a lower row of battery arrays. Similarly, the battery arrays 32b are arranged within the battery housing 30 in a side-by-side arrangement to form an upper row of battery arrays. Each battery array 32b of the upper row of battery arrays is vertically stacked on top of a respective battery array 32a of the lower row of battery arrays.

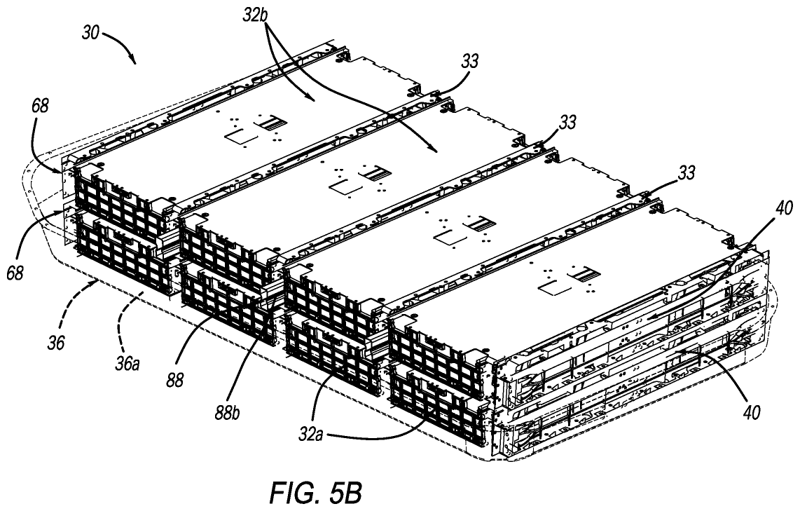

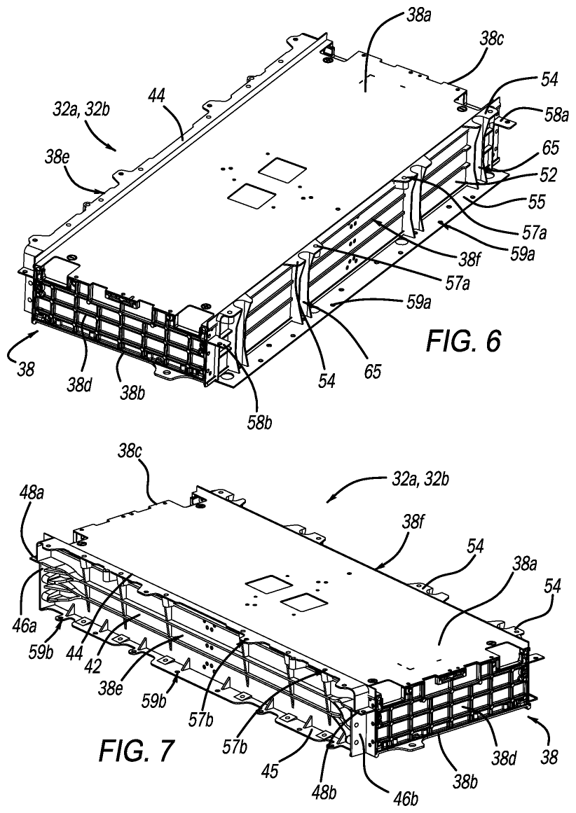

Each battery array 32a, 32b may be rechargeable and may be in the form of a modular structure that can be installed within and removed from the battery housing 30. Each battery array 32a, 32b also spans substantially an entire width of the battery housing 30. With reference to FIGS. 6 and 7, each battery array 32a, 32b includes a plurality of walls 38 that are secured to each other to form a unitized structure that houses and supports one or more cell stacks (not shown) formed by battery cells (e.g., lithium-ion batteries or any other suitable electrical power storage units). In some forms, the battery cells may be stacked on each other in a vertical arrangement within the unitized structure. In some forms, the battery cells may be arranged in a side-by-side configuration within the unitized structure.

The battery arrays 32a, 32b are secured to each other to form a structural assembly that is configured to transfer loads from one side of the battery housing 30 to an opposite side of the battery housing 30, for example, during a certain impact event. Stated differently, the battery arrays 32a, 32b are secured to each other to transfer loads away from the cell stacks located within each battery array 32a, 32b during a certain impact event.

Referring to FIGS. 6 and 7, the plurality of walls 38 of each battery array 32a, 32b include an upper wall 38a, a lower wall 38b, a right side wall 38c, a left side wall 38d, a front wall 38e and a rear wall 38f. Each of the walls 38a-38f are secured to each other to form a structural surrounding and sealed compartment for the cell stack. In the example illustrated, the structural surrounding has a box shape. The upper wall 38a defines an uppermost boundary of the battery array 32a, 32b and is oriented in a horizontal direction. Similarly, the lower wall 38b defines a lowermost boundary of the battery array 32a, 32b and is oriented in a horizontal direction. The right side wall 38c is oriented vertically and defines a rightmost boundary of the battery array 32a, 32b. Similarly, the left side wall 38d is oriented vertically and defines a leftmost boundary of the battery array 32a, 32b.

Referring to FIGS. 5A, 8 and 9, the front wall 38e of each battery array 32a, 32b is located further toward a front end of the vehicle 10 (arrow F indicates front end of the vehicle 10) than the rear wall 38f of the battery array 32a and is secured to the rear wall 32f of an adjacent battery array 32a, 32b. In this way, the front wall 38e of the battery array 32a, 32b and the rear wall 38f of the adjacent battery array 32a, 32b form a cross member or structure 33 that spans substantially an entire width of the battery housing 30 and that is configured to transfer loads from one side of the battery housing 30 to an opposite side of the battery housing 30, for example, during a certain impact event. Stated differently, the cross member 33 is configured to transfer loads away from the battery cells during a certain impact event. It should be understood that the battery array 32a, 32b located furthest forward in the battery housing 30 is secured to a wall 40. Stated differently, the front wall 38e of the battery array 32a, 32b located furthest forward in the battery housing 30 is secured to the wall 40. The wall 40 is secured to the battery housing 30 and may have structure that is similar or identical to the rear wall 38f, and therefore, will not be described again in detail.

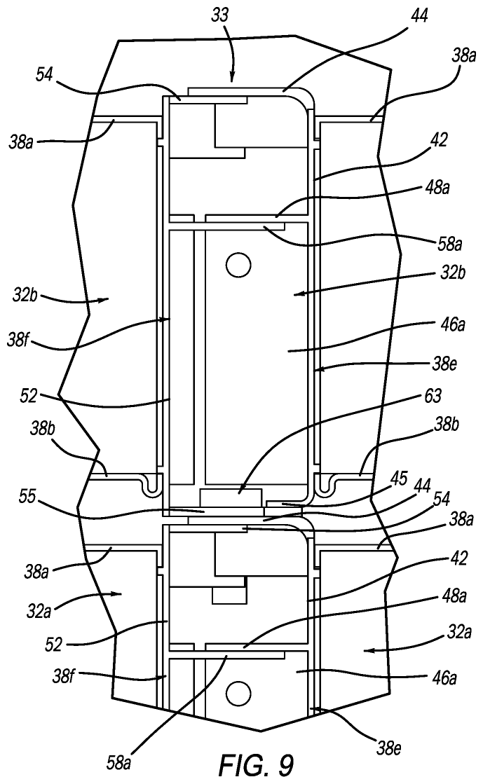

With reference to FIGS. 7-9, the front wall 38e of the battery array 32a, 32b includes a vertical portion 42, an upper portion 44, a lower portion 45, a pair of flanges 46a, 46b (FIG. 7) and a pair of ribs or tabs 48a, 48b (FIG. 7). The vertical portion 42 extends in a vertical direction and faces the rear wall 38f of an adjacent battery array 32a, 32b. In the example illustrated, the vertical portion 42 extends upward past the upper wall 38a (FIGS. 8 and 9) of the battery array 32a, 32b. In the example illustrated, the lower wall 38b of the battery array 32a, 32b is located closer toward the bottom wall 36b of the battery housing 30 than a lower end of the vertical portion 42. In some forms, the lower wall 38b of the battery array 32a, 32b is flush with the lower end of the vertical portion 42. In other forms, the lower end of the vertical portion 42 extends downward past the lower wall 38b of the battery array 32a, 32b.

The upper portion 44 extends perpendicular from an upper end of the vertical portion 42 towards the rear wall 38f of the adjacent battery array 32a, 32b. The upper portion 44 is oriented horizontally and is secured to the rear wall 38f of the adjacent battery array 32a, 32b. The lower portion 45 extends perpendicular from the lower end of the vertical portion 42 towards the rear wall 38f of the adjacent battery array 32a, 32b. The lower portion 45 is oriented horizontally and is secured to the rear wall 38f of the adjacent battery array 32a, 32b. The pair of flanges 46a, 46b extend perpendicular from the vertical portion 42 toward the rear wall 38f of the adjacent battery array 32a, 32b. The flange 46a is proximate the right side wall 38c (FIG. 7) and the flange 46b is proximate the left side wall 38d (FIG. 7). In this way, the pair of flanges 46a, 46b are spaced apart from each other and face each other. The pair of flanges 46a, 46b are also oriented in a vertical direction and are located between the upper end and the lower end of the vertical portion 42 (FIGS. 8 and 9). The pair of tabs 48a, 48b extend from the vertical portion 42 toward the rear wall 38f of the adjacent battery array 32a, 32b. The tab 48a is proximate the right side wall 38c (FIG. 7) and the tab 48b is proximate the left side wall 38d (FIG. 7). Stated differently, the tab 48a is located outboard relative to the flange 46a and the tab 48b is located outboard relative to the flange 46b. The pair of tabs 48a, 48b are also secured to the rear wall 38f of the adjacent battery array 32a, 32b. In the example illustrated, the pair of tabs 48a, 48b are located above the pair of flanges 46a, 46b and are oriented in a horizontal direction (FIG. 7). Stated differently, the pair of tabs 48a, 48b extend perpendicular to the pair of flanges 46a, 46b.

The rear wall 38f of the battery array 32a, 32b includes a vertical portion 52, a plurality of upper portions 54, a lower portion 55, and a pair of ribs or tabs 58a, 58b. The vertical portion 52 extends in a vertical direction and is spaced apart from the vertical portion 42 of the front wall 38e of the adjacent battery array 32a, 32b. In the example illustrated, the vertical portion 52 extends upward past the upper wall 38a of the battery array 32a, 32b (FIGS. 8 and 9) and extends downward past the bottom wall 38b of the battery array 32a, 32b (FIGS. 8 and 9).

The upper portions 54 are spaced apart from each other along a length of the vertical portion 52 and extend perpendicular from an upper end of the vertical portion 52 toward the vertical portion 42 of the front wall 38e of the adjacent battery array 32a, 32b. The upper portions 54 are oriented horizontally and are secured to the upper portion 44 of the front wall 38e of the adjacent battery array 32a, 32b by mechanical fasteners (not shown) such as rivets, bolts, or threaded screws, for example. That is, the mechanical fasteners extend through openings 57a (FIG. 6) of the upper portions 54 of the rear wall 38f and openings 57b (FIG. 7) of the upper portion 44 of the front wall 38e, thereby connecting the adjacent battery arrays 32a, 32b to each other.

The lower portion 55 extends perpendicular from a lower end of the vertical portion 52 towards the vertical portion 42 of the front wall 38e of the adjacent battery array 32a, 32b. That is, the lower portion 55 extends further toward the vertical portion 42 of the front wall 38e of the adjacent battery array 32a, 32b than the upper portions 54 of the rear wall 38f. As shown in FIG. 8, the lower portion 55 of the rear wall 38f of a respective battery array 32a is disposed on the central portion 37b of a respective cross beam 37 such that the respective battery array 32a is spaced apart from the bottom wall 36b of the battery housing 30.

Fasteners 61 (only one shown in FIG. 8) extend through the lower portion 55 of the rear wall 38f of the respective battery array 32a (via openings 59a, shown in FIG. 6), the lower portion 45 of the front wall 38e of the adjacent respective battery array 32a (via openings 59b, shown in FIG. 7), and the central portion 37b of the respective cross beam 37, thereby securing the respective cross beam 37 and the adjacent battery arrays 32a to each other. A head 61a of each fastener 61 is disposed within the cavity 41 formed by the cross beam 37 and the battery housing 30 such that each fastener 61 does not have to extend through the bottom wall 36b of the battery housing 30 to secure the rear wall 38f and the cross beam 37 to each other.

As shown in FIG. 9, the lower portion 55 of the rear wall 38f of a respective battery array 32b is disposed on the upper portion 44 of the front wall 38e of the battery 32a located in the lower row. In this way, fasteners 63 (only one shown in the figure) extend through the upper portion 54 of the rear wall 38f of the respective battery array 32a of the lower row, the upper portion 44 of the front wall 38e of an adjacent battery array 32a of the lower row, and the lower portion 55 of the rear wall 38f of the respective battery array 32b of the upper row, thereby securing the two adjacent battery arrays 32a of the lower row and the respective battery array 32b of the upper row to each other.

As shown in FIG. 6, reinforcement members 65 are connected to and spaced apart along the vertical portion 52 of the rear wall 38f. The reinforcement members 65 have an arcuate shape and extend from a respective upper portion 54 to the lower portion 55. The lower portion 55 extends further toward the vertical portion 42 of the front wall 38e of the adjacent battery array 32a, 32b than the reinforcement members 65.

The pair of tabs 58a, 58b extend from the vertical portion 52 toward the front wall 38e of the adjacent battery array 32a, 32b. The tab 58a is proximate the right side wall 38c of the vertical portion 52 and the tab 58b is proximate the left side wall 38d of the vertical portion 52. Each tab 58a, 58b is also secured to a respective tab 48a, 48b of the front wall 38e of the adjacent battery array 32a, 32b (only tab 58a is shown secured to the tab 48a in FIGS. 8 and 9) via mechanical fasteners (not shown) such as rivets, threaded screws, or bolts, for example. In the example illustrated, each tab 58a, 58b is oriented in a horizontal direction and is located below the respective tab 48a, 48b of the front wall 38e of the adjacent battery array 32a, 32b. In some forms, each tab 58a, 58b is located above the respective tab 48a, 48b of the front wall 38e of the adjacent battery array 32a, 32b.

It should be understood that the battery array 32a, 32b located furthest rearward in the battery housing 30 is secured to a wall 68. Stated differently, the rear wall 38f of the battery array 32a, 32b located furthest rearward in the battery housing 30 is secured to the wall 68. The wall 68 may have structure that is similar or identical to the front wall 38e of the battery arrays 32a, 32b, except that the wall 68 is not part of an adjacent battery array 32a, 32b, and therefore, will not be described again in detail.

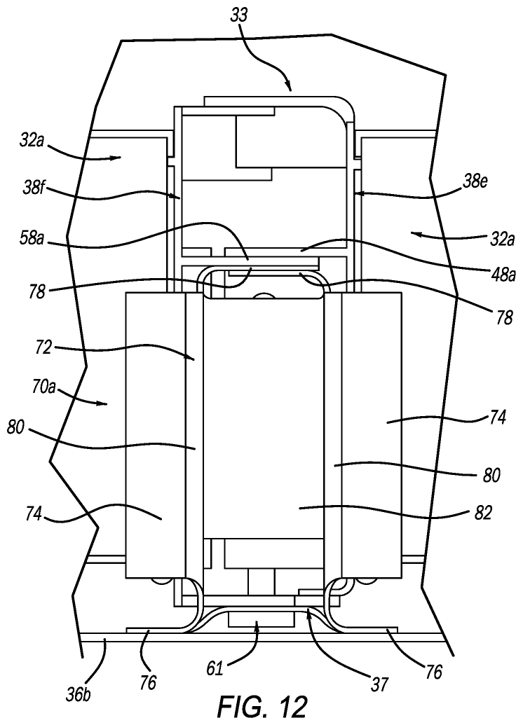

With reference to FIGS. 3, 4, and 12, a plurality of pairs of gussets 70 are disposed within and secured to the battery housing 30. In the example illustrated, the plurality of pairs of gussets 70 further secure the battery arrays 32a to the battery housing 30. In some forms, a plurality of pairs of gussets (not shown, e.g., similar to gussets 70) may secure the battery arrays 32b to the battery housing 30, instead of, or in addition to, the plurality of pairs of gussets 70 securing the battery arrays 32a to the battery housing 30.

Each pair of gussets 70 includes a left gusset 70a and a right gusset 70b. The left gusset 70a secures a respective cross member 33 to a left side wall 36a of the battery housing 30 and the right gusset 70b secures the respective cross member 33 to a right side wall 36a of the battery housing 30. Each gusset 70a, 70b includes a body 72, a pair of vertical flanges or walls 74, a pair of horizontal flanges or walls 76, and a pair of connecting members 78. The body 72 has a U-shape and includes a pair of vertical walls 80 and a connecting wall 82. The pair of vertical walls 80 are spaced apart from each other and extend in a vertical direction. The connecting wall 82 also extends in the vertical direction and connects the pair of vertical walls 80 to each other. Each vertical flange 74 extends perpendicular from a side of a respective vertical wall 80 and is secured to a respective side wall 36a of the battery housing 30. The pair of vertical flanges 74 are oriented in a vertical direction and extend away from each other.

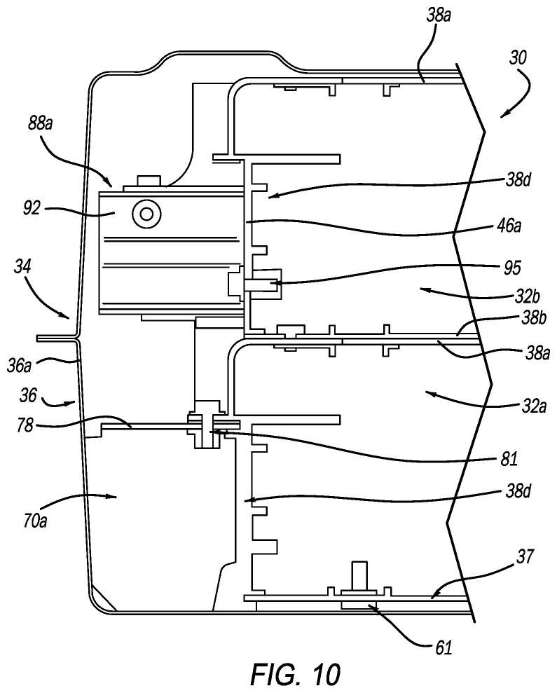

Each horizontal flange 76 extends perpendicular from a lower end of a respective vertical wall 80 and is secured to the bottom wall 36b of the battery housing 30. The pair of horizontal flanges 76 are oriented in a horizontal direction and extend away from each other. The connecting members 78 have arcuate shapes and extend perpendicular from upper ends of respective vertical walls 80 toward each other. In the example illustrated, the connecting members 78 of the gusset 70a are connected to each other and to respective tabs 48a, 58a of the walls 38e, 38f, respectively. That is, a fastener 81 (FIG. 10) such as a bolt, threaded screw, or rivet, for example, extends through the connecting members 78 of the gusset 70a and the tabs 48a, 58a of the walls 38e, 38f, respectively, to secure the gusset 70a and the walls 38e, 38f to each other. Similarly, the connecting members 78 of the gusset 70b are connected to each other and to the tabs 48b, 58b of the walls 38e, 38f, respectively. A fastener (not shown) such as a bolt, threaded screw, or rivet, for example, extends through the connecting members 78 of the gusset 70b and the tabs 48b, 58b of the walls 38e, 38f, respectively, to secure the gusset 70b and the walls 38e, 38f to each other.

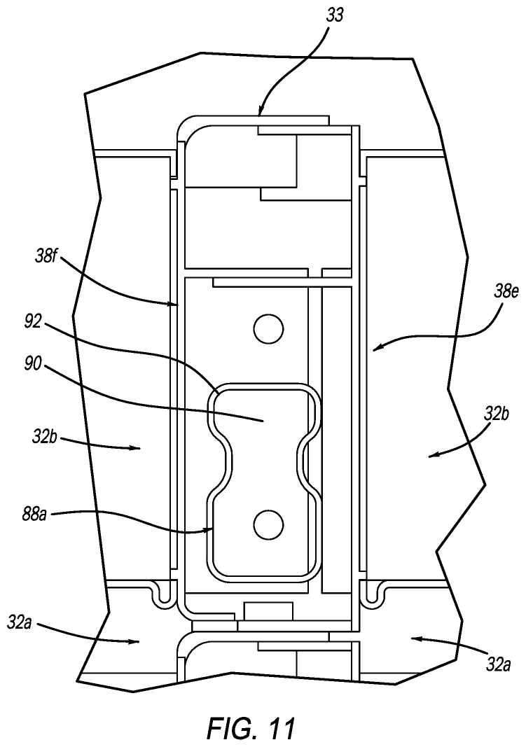

With reference to FIGS. 5a, 5b, 10, and 11, a plurality of pairs of energy absorbing structures 88 are disposed within the battery housing 30. In the example illustrated, each pair of energy absorbing structures 88 includes a left energy absorbing structure 88a (FIGS. 5a, 9, and 10) and a right energy absorbing structure 88b (FIG. 5b). The left energy absorbing structure 88a is secured to a left side of a respective cross member 33 of the upper row and extends toward the left side wall 36a of the battery housing 30 (and lid 34). The left energy absorbing structure 88a is vertically aligned with a respective gusset 70a and includes a plate portion 90 (FIG. 11) and an energy absorbing structure 92. The plate portion 90 is secured to a respective flange 46a of the front wall 38e by one or more fasteners 95 (FIG. 5) such as bolts, threaded screws, or rivets, for example. The energy absorbing structure 92 extends toward the left side wall 36a and is spaced apart from the left side wall 36a (FIG. 10). The right energy absorbing structure 88b is secured to a right side of the respective cross member 33 of the upper row and extends toward the right side wall 36a of the battery housing 30. The structure and function of the right energy absorbing structure 88b is similar or identical to that of the left energy absorbing structure 88a described above, and therefore, will not be described again in detail.

The battery structure 14 of the present disclosure provides battery arrays 32a, 32b that are secured to each other in a way that form a structural assembly configured to transfer loads from one side of the battery housing 30 to an opposite side of the battery housing 30, for example, during a certain impact event. The battery structure 14 of the present disclosure also provides energy absorbing structures 88 secured the cross members 33 so as to transfer side impact from one side of the battery housing 30 to an opposite side of the battery housing 30, for example, during a certain impact event. The battery structure 14 of the present disclosure also allows the battery arrays 32a, 32b to be stacked on top of each other from the bottom wall 36b of the battery housing 30 to the lid 34. In this way, the battery arrays 32b in the upper row may engage the lid 34.

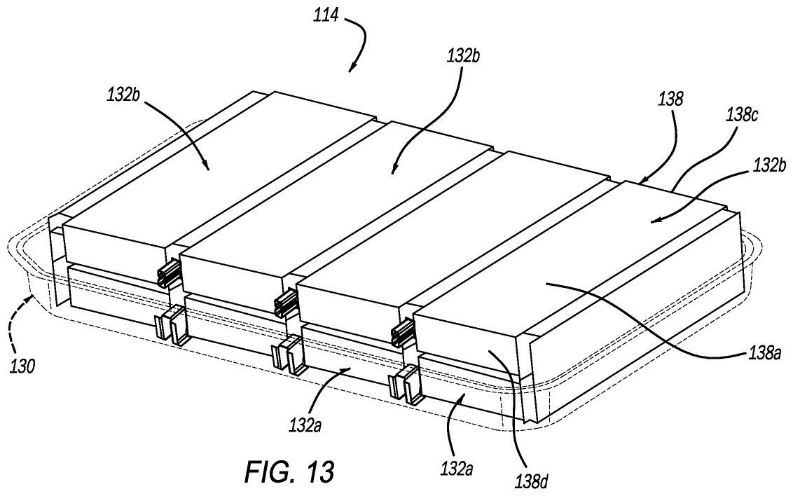

With reference to FIGS. 13-15, another battery housing assembly 114 is illustrated. The battery housing assembly 114 may be incorporated into the vehicle 10 described above instead of the battery housing assembly 14. The structure and function of the battery housing assembly 114 may be similar or identical to the battery housing assembly 14 described above, apart for any differences noted below.

The battery housing assembly 114 includes a battery tray or housing 130 and a plurality battery arrays 132a, 132b. The structure and function of the battery tray 130 is similar or identical to the battery tray 30 described above, and therefore, will not be described again in detail.

Each battery array 132a, 132b includes a plurality of walls 138 that are secured to each other to form a unitized structure that houses and supports one or more cell stacks (not shown) formed by battery cells (e.g., lithium-ion batteries or any other suitable electrical power storage units). The plurality of walls 138 of each battery array 132a, 132b include an upper wall 138a, a lower wall 138b, a right side wall 138c (FIG. 13), a left side wall 138d (FIG. 13), a front wall 138e and a rear wall 138f. The structure and function of the upper wall 138a, the lower wall 138b, the right side wall 138c, and the left side wall 138d are similar or identical to the upper wall 38a, the lower wall 38b, the right side wall 38c, and the left side wall 38d described above, respectively, therefore, will not be described again in detail.

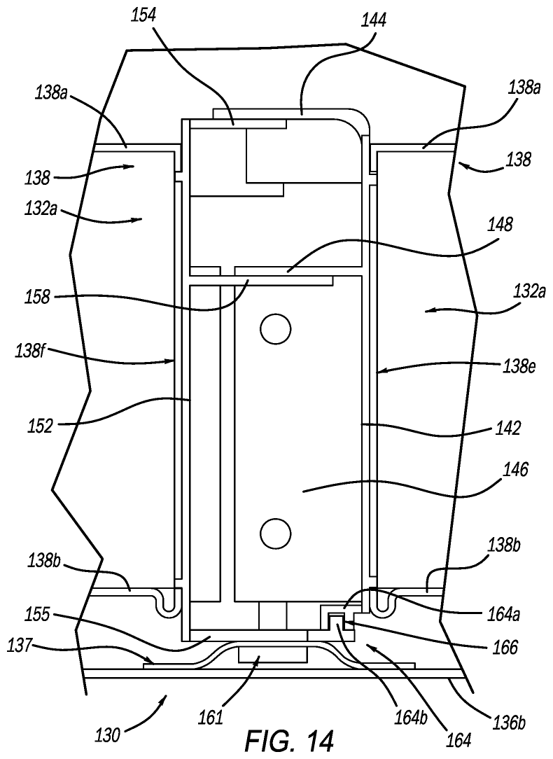

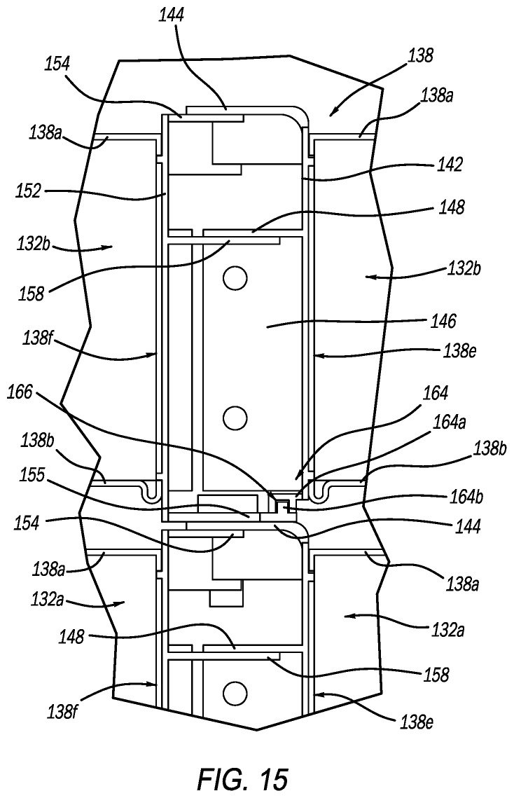

The front wall 138e of the battery array 132a, 132b includes a vertical portion 142, an upper portion 144, a pair of flanges 146 (only one shown in the FIGS. 14 and 15) and a pair of ribs or tabs 148 (only one shown in FIGS. 14 and 15). The vertical portion 142 extends in a vertical direction and faces the rear wall 138f of an adjacent battery array 132a, 132b.

With reference to FIGS. 14 and 15, the upper portion 144 extends perpendicular from an upper end of the vertical portion 142 towards the rear wall 138f of the adjacent battery array 132a, 132b. The upper portion 144 is oriented horizontally and is secured to the rear wall 138f of the adjacent battery array 132a, 132b. The structure and function of the pair of flanges 146 (only one shown in the figures) are similar or identical to the pair of flanges 46a, 46b described above, and therefore, will not be described again in detail. The structure and function of the pair of tabs 148 (only one shown in the figures) are similar or identical to the pair of tabs 48a, 48b described above, and therefore, will not be described again in detail.

The rear wall 138f of the battery array 132a, 132b includes a vertical portion 152, an upper portion 154, a lower portion 155, a pair of flanges 156 (only one shown in the figures) and a pair of ribs or tabs 158 (only one shown in the figures). The vertical portion 152 extends in a vertical direction and is spaced apart from the vertical portion 142 of the front wall 138e of the adjacent battery array 132a, 132b.

The upper portion 154 extends perpendicular from an upper end of the vertical portion 152 towards the vertical portion 142 of the front wall 138e of the adjacent battery array 132a, 132b. The upper portion 154 is oriented horizontally and is secured to the upper portion 144 of the front wall 138e of the adjacent battery array 132a, 132b by mechanical fasteners (not shown) such as rivets, bolts, or threaded screws, for example. The lower portion 155 extends perpendicular from a lower end of the vertical portion 152 towards the vertical portion 142 of the front wall 138e of the adjacent battery array 132a, 132b. That is, the lower portion 155 extends further toward the vertical portion 142 of the front wall 138e of the adjacent battery array 132a, 132b than the upper portion 154 of the rear wall 138f. The lower portion 155 of the rear wall 138f of a respective battery array 132a is disposed on a respective cross beam 137 such that the respective battery array 132a is spaced apart from a bottom wall 136b of a battery housing 130.

Fasteners 161 (only one shown in the figures) extend through the lower portion 155 of the rear wall 138f of the respective battery array 132a and the respective cross beam 137, thereby securing the respective cross beam 137 and the rear wall 138f to each other.

The lower portion 155 of the rear wall 138f of a respective battery array 132b is disposed on the upper portion 144 of the front wall 138e of the battery array 132a located in the lower row. In this way, fasteners (not shown) extend through the upper portion 154 of the rear wall 138f of the respective battery array 132a of the lower row, the upper portion 144 of the front wall 138e of an adjacent battery array 132a of the lower row, and the lower portion 155 of the rear wall 138f of the respective battery array 132b of the upper row, thereby securing the two adjacent battery arrays 132a of the lower row and the respective battery array 132b of the upper row to each other.

An interlock assembly 164 secures the lower portion 155 of the rear wall 138f of the battery array 132a, 132b to the vertical portion 142 of the front wall 138e of the adjacent battery array 132a, 132b. That is, in the example illustrated, the interlock assembly 164 includes a flange 164a and a protrusion 164b. The flange 164a extends from a lower end of the vertical portion 142 of the front wall 138e and defines a recess 166. The protrusion 164b extends upward from an end of the lower portion 155 of the rear wall 138f and is received in the recess 166 of the flange 164a, thereby interlocking the rear wall 138f of the battery array 132a, 132b and the front wall 138e of the adjacent battery array 132a, 132b to each other. In some forms, the flange 164a may be secured to the lower portion 155 of the rear wall 138f and the protrusion 164b may be secured to the front wall 138e without departing from the scope of the present disclosure.

The structure and function of the pair of tabs 158 (only one shown in the figures) are similar or identical to the pair of tabs 58a, 58b described above, and therefore, will not be described again in detail.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A battery structure for an electric vehicle, the battery structure comprising:
a first battery array comprising a plurality of first walls that are secured to each other to form a first unitized structure that is configured to house a first cell stack one first wall of the plurality of first walls includes a first vertical portion, a first upper portion, and a first lower portion; and
a second battery array comprising a plurality of second walls that are secured to each other to form a second unitized structure that is configured to house a second cell stack, one second wall of the plurality of second walls includes a second vertical portion and a second upper portion, the second vertical portion spaced apart from the first vertical portion, the second upper portion extends toward the first vertical portion from an upper end of the second vertical portion and is secured to the first upper portion of the first battery array,
wherein the first upper portion extends toward the second vertical portion from an upper end of the first vertical portion, the first lower portion extends toward the second vertical portion from a lower end of the first vertical portion and is connected to the one second wall.

2. The battery structure of claim 1, wherein:
the one first wall further includes a first rib extending from the first vertical portion from a location between the first upper portion and the first lower portion; and
the one second wall further includes a second rib extending from the second vertical portion and secured to the first rib.

3. The battery structure of claim 1, further comprising an interlock assembly securing the first lower portion of the one first wall to the one second wall.

4. The battery structure of claim 3, wherein the interlock assembly includes:
a flange defining a recess and extending from one of a lower end of the second vertical portion and an end of the first lower portion; and
a protrusion received in the recess of the flange and projecting from the other one of the lower end of the second vertical position and the end of the first lower portion.

5. The battery structure of claim 1, wherein the one second wall further includes a pair of flanges extending perpendicular from respective ends of the second vertical portion toward the first vertical portion.

6. The battery structure of claim 1, further comprising a third battery array stacked on the first battery array and comprising:
a plurality of third walls secured to each other to form a third unitized structure that is configured to house a third cell stack, one third wall of the plurality of third walls includes a third vertical portion and a second lower portion, the second lower portion extends toward the second vertical portion from a lower end of the third vertical portion and is secured to the first upper portion of the one first wall and secured to the second upper portion of the one second wall.

7. The battery structure of claim 1, wherein another first wall of the plurality of first walls of the first battery array is opposite the one first wall and includes a third vertical portion, a third upper portion, and a second lower portion, the third upper portion and the second lower portion extend from the third vertical portion in a direction away from the one first wall.

8. The battery structure of claim 7, further comprising a third battery array adjacent to the first battery array and connected to the another first wall of the first battery array.

9. The battery structure of claim 1, further comprising a plurality of mechanical fasteners extending through the first upper portion and through the second upper portion to secure the first upper portion and the second upper portion to each other.

10. A battery structure for an electric vehicle, the battery structure comprising:
a battery tray;
a plurality of cross beams supported by the battery tray and spaced apart from each other along a longitudinal direction of the electric vehicle, each cross beam extending in a transverse direction; and
a plurality of battery arrays disposed within the battery tray, the plurality of battery arrays comprising:
a first battery array comprising a plurality of first walls that are secured to each other to form a first unitized structure that is configured to house a first cell stack, one first wall of the plurality of first walls includes a first vertical portion, a first upper portion, and a first lower portion; and
a second battery array comprising a plurality of second walls that are secured to each other to form a second unitized structure that is configured to house a second cell stack, one second wall of the plurality of second walls includes a second vertical portion and a second upper portion, the second vertical portion spaced apart from the first vertical portion, the second upper portion extends toward the first vertical portion from an upper end of the second vertical portion and is secured to the first upper portion of the first battery array,
wherein the first upper portion and the first lower portion extend toward the second vertical portion from the first vertical portion, the first lower portion of the one first wall is connected to the one second wall and connected to one cross beam of the plurality of cross beams.

11. The battery structure of claim 10, wherein the one first wall and the one second wall are spaced apart from a bottom panel of the battery tray.

12. The battery structure of claim 10, wherein:
the one first wall further includes a first rib extending from the first vertical portion from a location between the first upper portion and the first lower portion; and
the one second wall further includes a second rib extending from the second vertical portion and engaging the first rib.

13. The battery structure of claim 12, further comprising a pair of gussets, each gusset secured to a respective side wall of the battery tray and secured to the first and second ribs.

14. The battery structure of claim 13, further comprising fasteners extending through a respective gusset of the pair of gussets and through the first and second ribs to secure the respective gusset to the first and second ribs.

15. The battery structure of claim 10, wherein the one second wall further includes a pair of flanges extending perpendicular from respective ends of the second vertical portion toward the first vertical portion.

16. The battery structure of claim 15, further comprising a pair of energy absorbing structures, each energy absorbing structure secured to a respective flange of the pair of flanges and extending outboard toward a respective wall of the battery tray.

17. The battery structure of claim 16, wherein the energy absorbing structure is spaced apart from the respective wall of the battery tray.

18. The battery structure of claim 10, further comprising an interlock assembly comprising:
a flange defining a recess and extending from one of a lower end of the second vertical portion and an end of the first lower portion; and
a protrusion received in the recess of the flange and projecting from the other one of the lower end of the second vertical position and the end of the first lower portion.

19. The battery structure of claim 10, further comprising a third battery array stacked on the first battery array and comprising:
a plurality of third walls secured to each other to form a third unitized structure that is configured to house a third cell stack, one third wall of the plurality of third walls includes a third vertical portion and a second lower portion, the second lower portion extends toward the second vertical portion from the third vertical portion and is secured to the first upper portion of the one first wall and secured to the second upper portion of the one second wall.

20. A battery structure for an electric vehicle, the battery structure comprising:
a battery tray;
a plurality of cross beams disposed on a bottom panel of the battery tray and spaced apart from each other along a longitudinal direction of the electric vehicle, each cross beam extending in a transverse direction;
a plurality of battery arrays disposed within the battery tray, the plurality of battery arrays comprising:
a first battery array comprising a plurality of first walls that are secured to each other to form a first unitized structure that is configured to house a first cell stack, one first wall of the plurality of first walls includes a first vertical portion, a first upper portion, and a first lower portion;
a second battery array comprising a plurality of second walls that are secured to each other to form a second unitized structure that is configured to house a second cell stack, one second wall of the plurality of second walls includes a second vertical portion, a second upper portion, and a pair of flanges, the second vertical portion spaced apart from the first vertical portion, the second upper portion extends toward the first vertical portion from the second vertical portion and is secured to the first upper portion of the first battery array, the pair of flanges extending perpendicular from respective ends of the second vertical portion toward the first vertical portion; and
a third battery array stacked on the first battery array and comprising a plurality of third walls secured to each other to form a third unitized structure that is configured to house a third cell stack, one third wall of the plurality of third walls includes a third vertical portion and a second lower portion, the second lower portion extends toward the second vertical portion from the third vertical portion and is secured to the first upper portion of the one first wall and secured to the second upper portion of the one second wall; and
a pair of energy absorbing structures, each energy absorbing structure secured to a respective flange of the pair of flanges and extending outboard toward a respective wall of the battery tray.
